(19) United States
(12) Patent Application Publication
(10) Pub. No.: US 2006/0040747 A1
(43) Pub. Date: Feb. 23, 2006

(54) Card Selling Apparatus

(75) Inventors: Yoshitaka Tao, Tokyo (JP); Kunihisa Yagishita, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignees: BANDAI CO., LTD., Tokyo (JP); KABUSHIKI KAISHA BANPRESTO, Tokyo (JP)

(21) Appl. No.: 11/161,862

(22) Filed: Aug. 19, 2005

(30) Foreign Application Priority Data
Aug. 20, 2004 (JP) 2004-241138

(51) Int. Cl. G06F 17/00

(52) U.S. Cl. 463/43

(57) ABSTRACT

A game apparatus or a card selling apparatus is provided with a plurality of card dispensers 610 in each of which a large number of cards are loaded and each of which dispenses a card in response to a dispense signal. This apparatus enables more cards to be accommodated in it than that in which only one card dispenser is mounted. In accordance with predetermined dispense conditions, one of the plurality of card dispensers 610 is selected to dispense a card. A card dispense signal is transmitted to the selected card dispenser.

### FIELD OF THE INVENTION

The present invention relates to a card selling apparatus for selling cards used in a game apparatus.

### BACKGROUND OF INVENTION

A bar coded card game apparatus has hitherto been proposed (Japanese Patent No. 3151978). The apparatus has a card dispensing device. The device dispenses a predetermined number of cards when coin detecting means senses a coin or when the game situation has turned to a player's advantage. Specifically, when the player wins, two cards are dispensed. When the player loses, no card is dispensed. Further, whenever a coin is input, a card is dispensed.

However, in the conventional art, data stored in the bar code is utilized for the game but not to control the type of card dispensed.

Further, the card selling apparatus according to the conventional art is equipped with only one card dispensing device. Accordingly, it is impossible to accommodate a large number of cards in the card selling apparatus. This means that the cards must be frequently loaded to the device, resulting in a heavy maintenance burden.

The present application proposes a game apparatus equipped with a plurality of card dispensing devices (card dispensers) as well as a card selling apparatus. This sharply increases the number of cards that can be accommodated in a game apparatus or the like.

The provision of a plurality of card dispensers extends the applications of the card selling apparatus. For example, by setting suitable conditions for dispensation of cards from the card dispenser, it is possible to enable the card selling apparatus not only to sell cards but also to amuse the player.

By the way, the conventional art simply allows the player to play games using cards and does not pay attention to the value of collection of cards themselves. For example, if the number of card types used was increased and the number of cards distributed were controlled according to the card types, a collection value would be created on the basis of the number of cards distributed. In particular, cards with low distributions are considered to be rare and have high collection values. On the other hand, to increase the number of a certain type of cards distributed, it may be realized by increasing the probability of dispensing the card. However, for cards with high dispense probabilities, the cards stocked in the selling apparatus runs out quickly. Thus, desirably, cards with high dispense probabilities can be refilled into the selling apparatus more easily than those with low dispense probabilities.

By thus setting a plurality of value levels for a card, it is possible not only to use the card for games but also to create a card collection value.

On the other hand, the card can be dispensed to all the users at the same probability. However, the number of devoted players can be increased by treating players well who have invested much money. This is economically preferable. Therefore, the card dispense conditions are desirably made more lenient depending on the amount of investment made by the player.

Since game machines for business use such as card selling apparatuses are installed throughout the nation, the player may utilize a plurality of card selling apparatuses installed in different places. In this case, if the amount of money invested by each player is totaled for each card selling apparatus, the player's investment may be distributed. Consequently, the player may not be sufficiently treated well according to the investment. Therefore, it is more preferable that player's dispense condition should be treated well based on the player's total of the investment distributed among the apparatus.

It is important that the dispense conditions be made more lenient depending on the amount of money invested. However, if the player were treated well according to his or her originality and ideas on the game, the game would be more amusing. For example, if the dispense conditions varied depending on combinations of a large number of card types, the player would enjoy searching for the optimum combination. However, in the conventional art, the number of cards dispensed is controlled depending only on whether the player has won or lost. It is thus impossible to dispense different types of cards depending on whether the player has won or lost or on combinations of cards used for the game apparatus. Thus, the possible enjoyment is limited.

With a game apparatus containing a card selling apparatus, cards may be dispensed at the beginning or end of a game. However, some players are taken no interest in playing the game but are enthusiastic about collection of cards. In this case, the player (card collector) cannot buy the next card until the game is over and may feel dissatisfied. Further, in regard to business, the turnover rate of the apparatus may not be fully improved. Thus, it is desirable that the player can buy the next card without the need to finish the game.

### SUMMARY OF THE INVENTION

An object of the present invention is to solve these and other problems. Other objects of the present invention will be understood by reading the entire specification.

To accomplish the object, the present invention provides a card selling apparatus which sells a card comprising a recording medium on which data for a game is recorded, the apparatus including a plurality of card dispensers in which a plurality of the cards are housed and from which the card is dispensed in response to a dispense signal, and a control unit which selects one of the plurality of card dispensers which is to dispense a card, in accordance with predetermined dispense conditions, the control unit transmitting the dispense signal to the selected card dispenser.

According to the present invention, the plurality of card dispensers are mounted in the card selling apparatus or game apparatus. This makes it possible to load a large number of cards in the apparatus. Further, the plurality of card dispensers are controlled in accordance with the predetermined dispense conditions. Consequently, the plurality of card dispensers can be effectively utilized.

For example, when card groups with different value levels are located into a first and second card dispensers of the plurality of card dispensers, the player can enjoy collecting dispensed cards. Of course, the number of value levels is not limited to two but may be three or more.

Cards with a lower value level have a higher dispense probability than cards with a higher value level and thus decrease more quickly. Thus, a plurality of card dispensers are assigned to cards with a relatively low value level. When these card dispensers are further arranged adjacent to each other, a card refiller can refill cards without being at a loss which card dispenser to be refilled. This configuration improves the maintenance property of the apparatus compared to the configuration in which the same card group is mounted in card dispensers that are not arranged adjacent to each other.

The value levels of cards are often determined by the number of cards distributed on the market. Accordingly, the value level of each card can be controlled by appropriately adjusting the dispense probability. That is, for the card the value level of which is to be relatively increased, its dispense probability may be set at a relatively small value.

When the dispense conditions are determined on the basis of cards used for the game, the player can enjoy searching for the optimum card. In particular, when a plurality of cards are used for the game, the dispense conditions can be determined on the basis of combinations of cards used. Consequently, the player can enjoy searching for the optimum combination of cards.

Further, when the dispense conditions are made more lenient depending on the amount of money invested by each player (the number of cards purchased), players having invested relatively much money can be treated well. By allowing a plurality of card selling apparatuses to share information on the number of cards purchased by each player, it is possible to suitably treat each player well.

Furthermore, by mounting a card sale mode and a game mode in the apparatus, it is possible to suitably sell cards to players devoted to collection of cards. This also makes it possible to improve the turnover rate of the card selling apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a perspective view showing the front appearance of an apparatus according to the present embodiment;

FIG. 2 is a perspective view showing the rear appearance of the apparatus according to the present embodiment;

FIG. 3 is a front view of the apparatus according to the present embodiment;

FIG. 4 is a plan view of the apparatus according to the present embodiment;

FIG. 5 is a right side view of the apparatus according to the present embodiment;

FIG. 6 is a sectional view of the apparatus according to the present embodiment;

FIG. 7 is a perspective view showing that a first maintenance door 130 according to the present embodiment is opened;

FIG. 8 is a front view showing that a second maintenance door 140 according to the present embodiment is unlocked;

FIG. 9 is a perspective view showing that the second maintenance door 140 according to the present embodiment is unlocked;

FIGS. 10A and 10B are plan views of a card slope according to the embodiment;

FIGS. 11L and 11R are side views of the card slope according to the embodiment;

FIGS. 12A and 12B are bottom views of the card slope according to the embodiment;

FIG. 13 is a perspective view of an illustrative card dispenser;

FIG. 14 is a diagram showing an example of a card refilling operation;

FIG. 15 is a block diagram showing an example of a control device according to the present embodiment;

FIG. 16 is a flowchart showing an example of a control program according to the present embodiment;

FIG. 17 is a diagram showing an example of an apparatus using a biometrics sensor;

FIG. 18 is a diagram showing an example of a database according to the embodiment;

FIG. 19 is a sequence diagram showing an example according to the present embodiment;

FIG. 20 is a flowchart showing an example of a game process according to the present embodiment;

FIG. 21 is a diagram showing an example of a card combination managing table; and

FIG. 22 is a flowchart showing an example of another dispense condition making-lenient process according to the embodiment.

### DETAILED DESCRIPTION OF THE PREFERRED EMBODIMENTS

Preferred embodiments of the present invention will now be described in detail in accordance with the accompanying drawings.

An embodiment of the present invention will be shown below which is useful in understanding the super-, mid-, and sub-concepts of the present invention. The claims do not set forth all the concepts included in the embodiment described below. However, this does not mean that some concepts are intentionally excluded from the scope of the patent invention. It should be appreciated that since the embodiment is equivalent to the patent invention, not all the concepts are set forth in the claims.

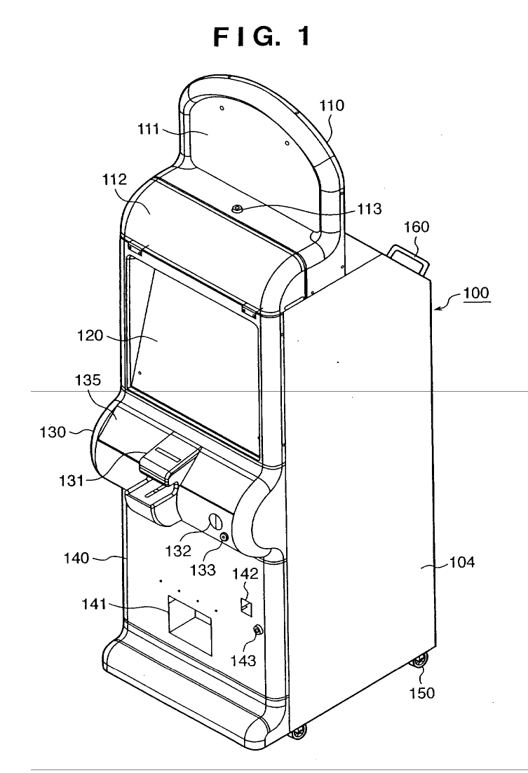

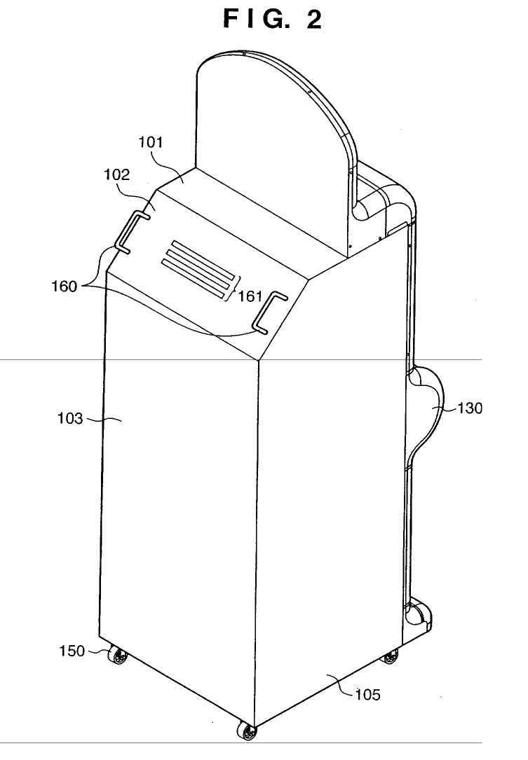

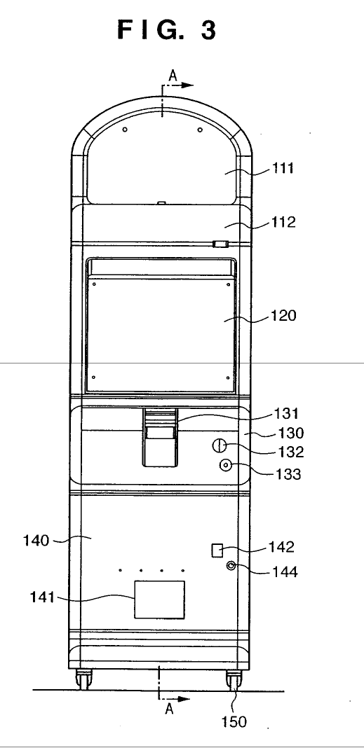

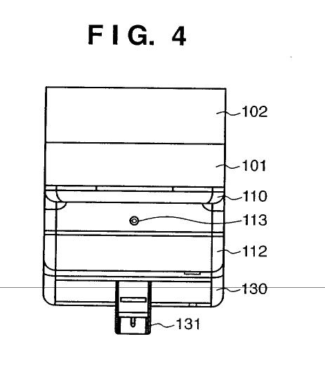

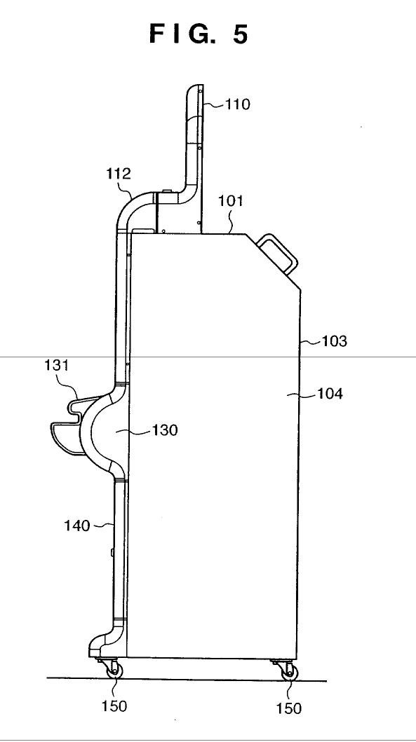

FIGS. 1 and 2 are perspective views showing the appearance of an apparatus according to the present embodiment. FIG. 3 is a front view of the apparatus according to the present embodiment. FIG. 4 is a plan view of the apparatus according to the present embodiment. FIG. 5 is a right side view of the apparatus according to the present embodiment.

A housing 100 includes an upper panel 101, an inclined panel 102, a rear panel 103, a right-hand panel 104, and a left-hand panel 105. A display unit 110 is installed on the upper panel 101. The display unit 110 includes a poster display panel 111 and a card display unit 112. The card display unit 112 can be locked by inserting a key into a cylinder 113 and rotating it.

The display panel 120 is provided in the front of the housing 100. A first maintenance door 130 is provided below the display panel 120. An information reading unit 131 is provided in the center of the first maintenance door 130 in order to read information from a storage medium attached to a card. A coin input port 132 is provided on the right side of the information reading unit 131. A cylinder 133 and an operation panel 135 are provided in the lower right of the coin input port 132; the cylinder 133 is used to lock the first maintenance door 130 and operation buttons are arranged on the operation panel 135. The height up to a central portion of the operation panel 135 is desirably about 700 to about 900 mm. These values are used because most players of the present apparatus are in their early teens.

A second maintenance door 140 is provided below the first maintenance door 130. The second maintenance door is further provided with a card output port 141, a coin return port 142, and a cylinder 143 used to lock the second maintenance door 140. Further, four casters 150 are provided on a bottom panel of the housing 100.

The upper part of rear surface of the housing 100 is composed of the inclined panel 102 in order to avoid an increase in internal temperature caused by released heat. That is, when placed in a store, the game apparatus or card selling apparatus according to the present embodiment is desirably installed as close to the wall surface of the store or the like as possible in view of space efficiency. However, if there is not a sufficient space between the wall surface and the housing 100, heat cannot be released. Thus, the inclined panel 102 is provided at the upper part of the housing 100 to set a sufficient distance from the wall distance. Further, heat release ports 161 are formed to improve heat release efficiency.

Handles 160 are formed on the opposite sides of the inclined panel 102 to prevent burglaries. In particular, in this example, the handles are shaped like semicircles so that wires or the like for burglary prevention can be easily locked on the handles. In conventional game apparatuses or the like, dents are formed on side surfaces of the apparatus so at handles can be formed in the dents. Consequently, a locking unit for burglary prevention must be separately provided. Further, the dents in the side surfaces may obstruct certain components inside the apparatus. In the present embodiment, the handles 160 are provided on the inclined panel 102. This advantageously provides a sufficient space inside the apparatus and allows the omission of a separate locking unit for burglary prevention.

Each of the handles 160 is desirably installed so that its central portion is located at a height of about 800 to about 1,500 mm from the ground. This is because the apparatus with the handles can be easily pushed when the handles are located at a height between the vicinity of the player's waist and the vicinity of the player's shoulders. According to the survey conducted by the Ministry of Education, Culture, Sports, Science and Technology in 2002, the average height of Japanese men (17 years old) is 1,700 mm. Thus, the average height of the waist is about 800 mm and the average height of the shoulders is about 1,500 mm. More preferably, the handles 160 located at a height of 1,000 to 1,300 mm allow an apparatus installer to easily exert a force on the handles with his or her hands without the need to take an unnatural position. The above values are determined using the average height of Japanese men as a model. Thus, if the apparatus according to the present embodiment is used in a different country, the mounting positions of the handles 160 may be adjusted according to the average height in that country.

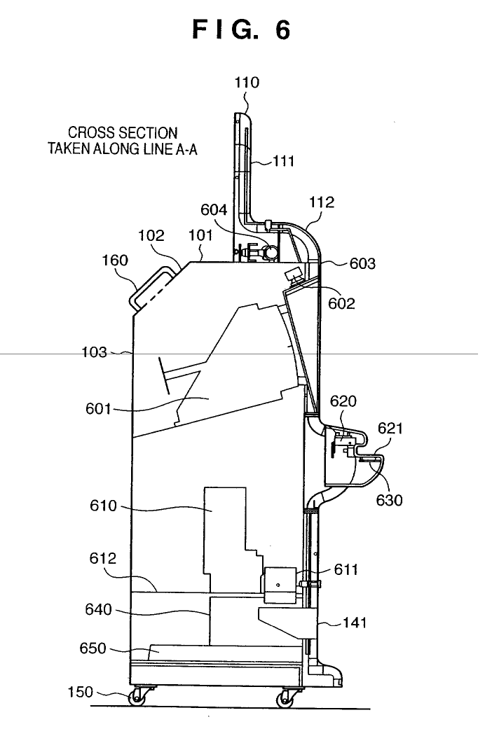

FIG. 6 is a sectional view of the apparatus according to the present embodiment. More specifically, this figure shows a cross section of the apparatus taken along line A-A that is a centerline of the front view shown in FIG. 3. The apparatus contains, for example, a display device 601 that displays a game screen, a card sale screen, and the like, a speaker 602 that outputs sound effects for a game, a hinge 603 that enables a display unit 112 to be opened and closed, and a illumination device 604 such as a fluorescent tube which illuminates the display unit 112. A display screen of the display device 601 is provided opposite the display panel 120. The screen size of the display device 601 is desirably 14 or 15 inches but is not necessarily limited to this.

Further, below the display device 601, a plurality of card dispensers 610 are mounted on a lower partitioning plate 612. A card slope 611 is a guide path through which cards dispensed by the plurality of card dispensers 610 are guided to the output port 141. A non-contact bar code scanner 620 is mounted on the information reading unit 131 to read a bar code from a card placed on the reading table 621. Although a conventional contact bar code scanner may be employed, the non-contact bar code scanner 620 is convenient even to players interested in collection of cards because it can suppress the abrasion of cards.

An e scanner device 630 may be provided under the reading unit 131. The e scanner is a technique for using a camera to read the carbon in ink printed on a card or the like to acquire information. The e scanner uses special ink invisible to human beings and can thus improve the appearance of the card compared to the conventional bar code printed using black ink. Further, if this ink is used to print a bar code on a card and the e scanner device 630 is used to read it, the bar code can advantageously be read at whatever angle the card is placed in a horizontal direction. Additionally, the e scanner device 630 can detect the angle or direction at which the card is located. For example, the processing described below is possible. If the card is placed with its long sides extending in a vertical direction with respect to the e scanner device 630, this is considered to be an instruction on an attack. If the card is placed with its long sides extending in the horizontal direction with respect to the e scanner device 630, this is considered to be an instruction on a defense.

A coin housing unit 640 is provided below the lower partitioning plate 612 to house coins input through the coin input port 132. A control circuit board 650 is mounted inside the housing 100 at the lowermost position to integrally control the whole apparatus.

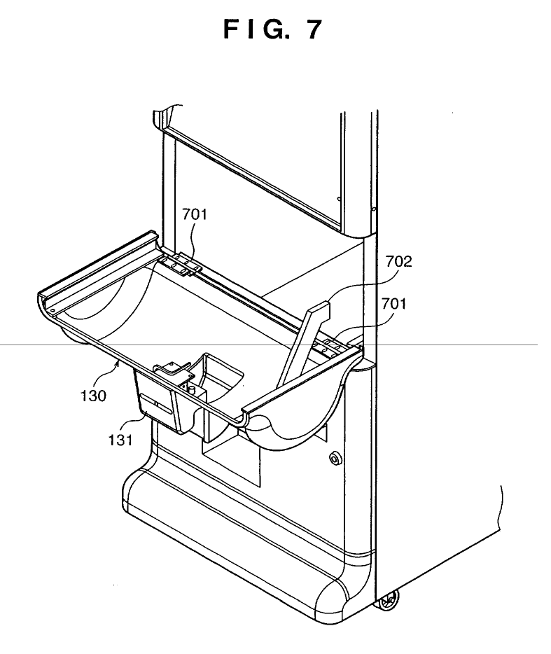

FIG. 7 is a perspective view showing that the first maintenance door 130 according to the present embodiment is opened. The first maintenance door 130 is supported by a right- and left-hand hinges 701 so that it can be opened and closed. A coin guide path 702 is a member through which coins input through the coin input port 132 are guided to a coin sensing unit 901.

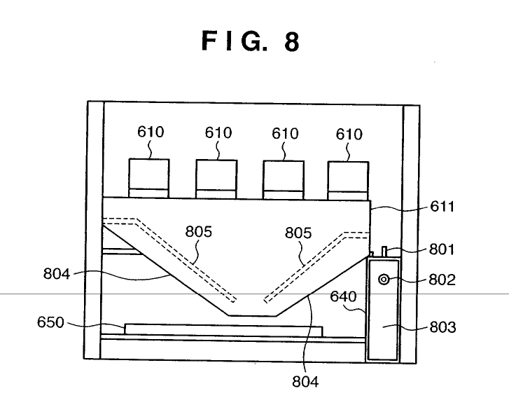

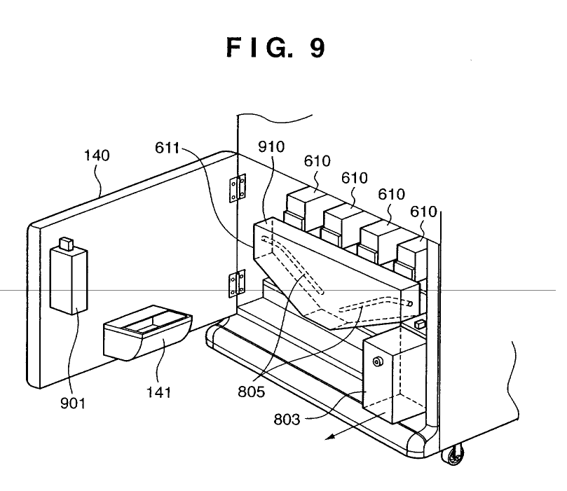

FIG. 8 is a front view showing that the second maintenance door 140 according to the present embodiment is unlocked. FIG. 9 is a perspective view showing that the second maintenance door 140 according to the present embodiment is unlocked. The coin sensing unit 901 and the card output port 141 are provided on a back surface of the second maintenance door 140.

The coin housing unit 640 has a withdrawer 803 that can be withdrawn only toward the front of the housing. A housing port 801 is provided at the top of the coin housing unit 640 to receive coins falling through the coin guide path 702. The withdrawer 803 cannot be withdrawn unless a cylinder 802 is unlocked.

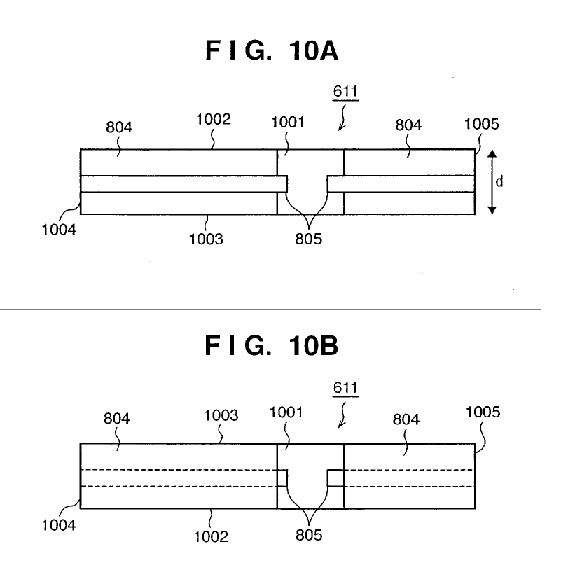

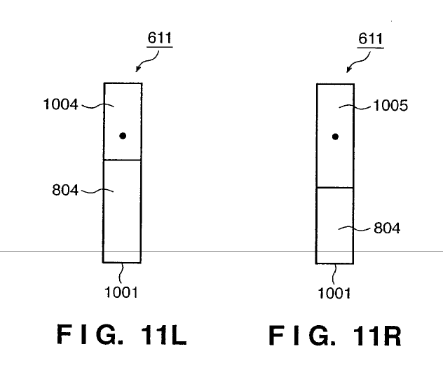

FIG. 10A is a plan view of the card slope according to the embodiment. FIG. 10B is a plan view of the card slope according to the embodiment. FIG. 11L is a left side view of the card slope according to the embodiment. FIG. 11R is a right side view of the card slope according to the embodiment. In the figures, reference numeral 1001 denotes a lower opening. Reference numeral 1002 denotes a rear wall. Reference numeral 1003 denotes a front wall. The rear is a direction toward the card dispenser 610, whereas the front is a direction toward the second maintenance door 140. Reference numeral 1004 denotes a left side wall. Reference numeral 1005 denotes a right side wall.

The card slope 611 is located so that it can receive cards dispensed by the plurality of card dispensers 610. The card slope 611 is generally hexagonal as viewed from the front surface. The lower opening 1001 has a smaller opening cross section (obtained by cutting the lower opening along the horizontal direction) than an upper opening 910 and is thus generally conical. The card slope 611 has slope portions 804 on the opposite sides; a part of the opening cross section of each slope portion decreases gradually from top to bottom. The card slope 611 allows cards dispensed by the card dispensers to be guided to the output port 141.

Card sticking preventing members 805 are provided in the card slope 611 along the slope portions 804 to prevent cards from being stuck as a result of condensation or the like. In the illustrated example, each of the card sticking preventing members 805 is shaped like a bar. One end of the preventing member 805 is attached to the left side wall 1004 or right side wall 1005 of the card slope by welding. Condensation is particularly prone to occur when the card slope 611 is formed of metal. Another cause of condensation is the fact that the apparatus according to the present embodiment is often installed outdoors, or even indoors, in a place where it is exposed to the open air.

The card sticking preventing members 805 are placed at a certain distance from the surfaces of the slope portions 804. This distance depends on the length of short sides of the card and the length d of short sides of the slope portion 804. The distance is such that the card does not slip in between the surface of the slope portions 804 and the card sticking preventing member 805. For example, it is assumed that the card sticking preventing members 805 are placed along the centerline of the card slope 611 as shown in FIGS. 10 and 11. Further, let d be the length of each short side of the slope portions 804. Let b denote the length of each short side of the card. Then, the condition to be met by the shortest distance c from the slope potion 804 to the sticking preventing members 805 is 0<c<(b²−0.25d²)^{0.5} on the basis of the Pythagorean theorem. More preferably, about 0.3b<c< about 0.7b. Under this condition, even if one of the long sides of the card abuts against the junction between the slope portions 804 and the front side wall 1003, part of the card is caught on the sticking preventing members 805.

In the illustrated example, the sticking preventing members 805 are provided on both the right and left sides. However, if the slope portion has an inclination of at least 45°, the sticking preventing members 805 may be omitted. If for example, the right-hand slope portion 804 is inclined at 50° and the left-hand slope potion 804 is inclined at 35°, the sticking preventing member 805 may be provided only on the left side.

A factor different from condensation may stick the card to the inside of the card slope 611. The sticking may occur if for example, the depth d (FIG. 10A) of the card slope 611 is shorter than the long side of the card. In particular, the sticking is likely to occur if the direction of short sides of the opening in the card slope 611 coincides with the dispensing direction of the card dispenser 610 as shown in the figure. The sticking occurs as follows. If one short side of the card abuts against an end (for example, a corner formed by the slope portion 804 and front side wall 1003) of the slope portion 804, the other short side of the card abuts against the opposite side wall (rear side wall 1004). Then, the friction between the card and the side wall hinders the card from falling.

Thus, provision of the sticking preventing members 805 makes it possible to prevent the card from being stuck. In this case, the sticking preventing members 805 are arranged at spatial positions such that if one short side of the card abuts against an end (corner formed by the slope portion 804 and the front or rear wall) of the slope portion 804, the other short side does not abut against the opposite side wall.

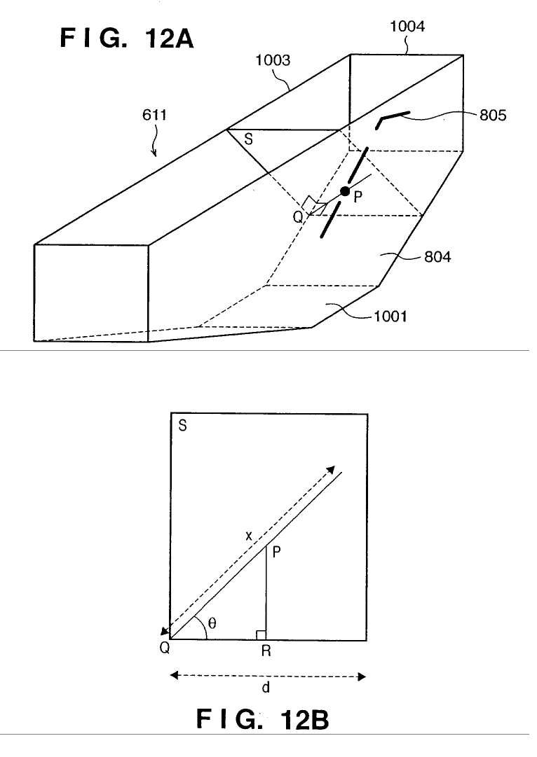

FIGS. 12A and 12B are diagrams illustrating sticking suppression conditions. Here, the sticking suppression conditions will be described using formulae. First, let x be the length of each long side of the card. A plane s is assumed which is orthogonal to both the surfaces of the slope portions 804 and the front side wall 1003. Let P denote the point at which the preventing members 805 cross the plane s. Moreover, a perpendicular is drawn from the point P to the above corner. Let Q denote the point of intersection between the perpendicular and the corner. The corner is a segment formed by the point of intersection between the surfaces of the slope portions 804 and the surface of the front side wall 1003. Further, a perpendicular is drawn from the point P to the slope portion 804. Let R be the point of intersection between the perpendicular and the slope portions 804. Let Θ be the angle between a line PQ and a line QR. Here, Θ may exceed Cos⁻¹(d/x) in order that while one short side of the card abuts against the corner, the other short side does not abut against the side wall (however, Θ is desirably at most 70°, preferably at most 50° in order to prevent the card from slipping to below the preventing members 805). When the preventing members 805 are excessively close to one of the side walls, the card may slip to under the preventing members 805. Thus, the preventing members 805 should be located at a position offset, toward the rear side wall, from a position where it stands at an equal distance from the front and rear side walls. The amount of offset is suitably 0 to 0.25d. A precondition for these calculations is that the card is discharged from the rear side wall 1002 toward front side wall 1003 of the card slope 611 as shown in FIGS. 8 and 9.

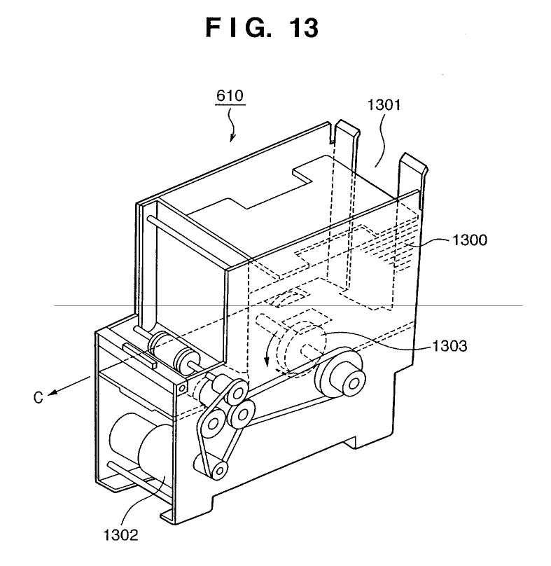

FIG. 13 is a perspective view of an illustrative card dispenser. Arbitrary card dispensers 610 may be used, for example, the card dispensing apparatus described in Japanese Patent Laid-Open No. 1995-20780 or the card dispenser (CD-200) manufactured by Asahi Seiko Co., Ltd. According to Japanese Patent Laid-Open No. 1995-20780, a card accommodating unit 1301 is provided in the upper part of the card dispenser 610; the card accommodating unit 1301 can accommodate hundreds of cards 1300. A motor 1302 rotates a delivery roller 1303 to discharge the lowermost card 1300 in the direction of an arrow C in the figure.

As shown in FIGS. 8 and 9, the present embodiment is equipped with the plurality of card dispensers 610. The provision of the plurality of card dispensers 610 enables more cards to be accommodated in the housing 100 than the provision of a single card dispenser as in the case of the conventional art. That is, the number of maintenance operations can be reduced. Moreover, normal cards with a relatively low collection value (relatively high dispense probability) are loaded into two of the four card dispensers 610 which are located on the left side. Rare cards with a higher collection value (lower dispense probability) than the normal cards are loaded into the third card dispenser 610 from the left. Super rare cards with the highest collection value (lowest dispense probability) are loaded into the fourth card dispenser 610 from the left end. By thus using the card dispensers 610 according to the value level or dispense probability, maintenance operations can be easily performed according to card types. That is, cards with high dispense probabilities are exhausted quickly. Accordingly, more card dispensers 610 are assigned to these cards than to cards with low dispense probabilities. If there are a plurality of card dispensers 610 for cards classified into the same value level, these card dispensers 610 are arranged adjacent to each other. For example, the card dispensers 610 for normal cards are arranged at the leftmost position and at the second position from the left end. Thus, a card refiller can easily refill cards without mistaking the card type. Further, the card dispensers 610 are arranged from left to right in order of increasing value level in view of the easiness with which the card refiller refills the card dispenser.

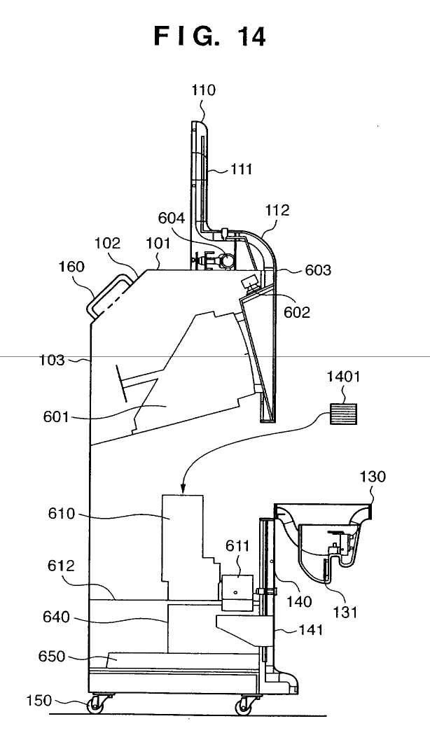

FIG. 14 is a diagram showing an example of a card refilling operation. According to the present embodiment, cards can advantageously be refilled simply by opening the first maintenance door 130. This is because the first maintenance door 130 for card loading is provided above the card dispenser 610. Furthermore, the second maintenance door 140, which covers the coin housing unit 640, need not be unlocked. This makes it possible to keep coins safe.

Further, as is apparent from FIGS. 8, 9, and 14, a withdrawer 803 in the coin housing unit 640 cannot be withdrawn unless the second maintenance door 140 is opened. That is, the coin housing unit 640 is provided at the position where coins cannot be recovered from the coin housing unit 640 even when the first maintenance door 130 is opened. Accordingly, coins can be ensured to be safe.

The safety of coins can be easily improved by using at least different keys to open the first maintenance door 130 and the second maintenance door 140. The safety of coins can further be improved by using, for the coin housing unit 640, a key different from the above keys. The keys may be hachiman locks or the like.

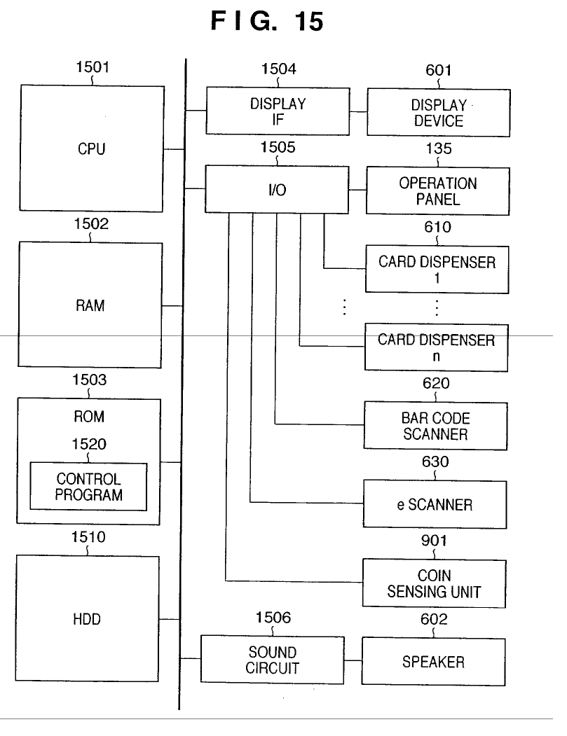

FIG. 15 is a block diagram showing an example of a control device according to the present embodiment. A CPU 1501 is a central processing unit that integrally controls the apparatus according to the present embodiment. A RAM 1502 is storage means for storing various data in association with operations of the CPU 1501. A ROM 1503 is storage means for storing a control program 1520 according to the present embodiment. The control program 1520 may be supplied by a CDROM or DVDROM (not shown). A hard disk drive 1510 is storage means for storing character data associated with the control program 1520 as well as card sales data.

A display interface 1504 is a video circuit that causes the display device 601 to display various pieces of information.

An I/O unit 1505 is an I/O interface to which various input devices are connected. Various switches are provided on the operation panel 135, connected to the I/O unit 1505. For example, the operation panel is provided with three buttons for a first player and three buttons for a second player.

The first card dispenser 610 to the n-th card dispenser 610 are connected to the I/O unit 1505. When the I/O unit 1505 outputs a dispense signal, the card dispenser 610 dispenses one card. The coin sensing unit 901 is also connected to the I/O unit 1505. A coin input signal is transmitted to the CPU 1501 via the I/O unit 1505.

The bar code scanner 620 and the e scanner 630 are also connected to the I/O unit 1505. Read data is transmitted to the CPU 1501 via the I/O unit 1505.

A sound circuit 1506 generates various sound signals in response to instructions from the CPU 1501 and outputs the signals to the speaker 602. The sound signals include sound effects and voice guidance.

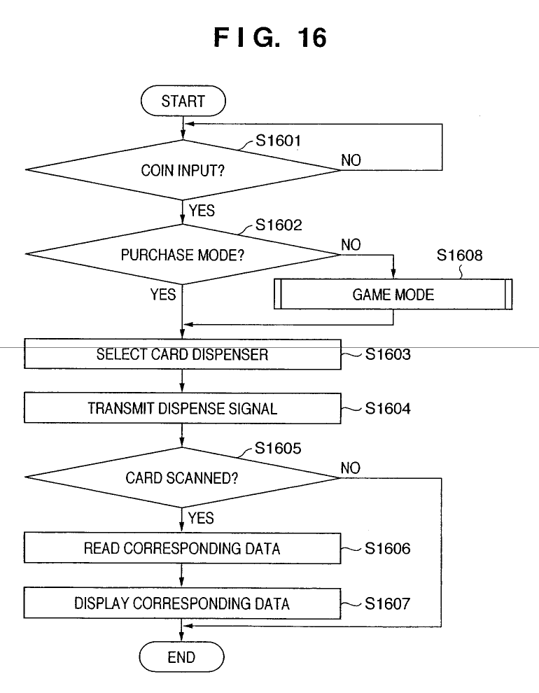

FIG. 16 is a flowchart showing an example of a control program according to the present embodiment. In this example, the apparatus according to the present embodiment is assumed to function as both a card selling apparatus and a card game apparatus. However, the present invention may be applied to only one of the apparatuses.

In step S1601, the CPU 1501 determines whether or not the coin sensing unit 901 has sensed the input of a coin. For example, the CPU 1501 may execute polling on the coin sensing unit 901 to determine whether or not a coin input sensing signal is being generated. Alternatively, the CPU 1501 may sense the input of a coin on the basis of an interruption signal from the coin sensing signal. If the input of a coin is sensed, the CPU 1501 proceeds to step S1602.

In step S1602, the CPU 1501 determines whether or not a purchase mode has been selected using a mode selection button on the operation panel 135. If the purchase mode has been selected, the CPU 1501 proceeds to step S1603 to skip the game and transmit a card dispense signal. On the other hand, if a game mode has been selected, the CPU 1501 proceeds to step S1608 to execute a process for the game.

In step S1603, the CPU 1501 selects at least one of the plurality of card dispensers 610 from which a card is to be dispensed, in accordance with the dispense conditions. The dispense conditions may be incorporated into the control program 1520 or separately stored in the ROM 1503 as data.

As the dispense conditions, different dispense probabilities may be set for the respective card types. For example, the dispense probability of normal cards is set at 70%. The dispense probability of rare cards is set at 20%. The dispense probability of super rare cards is set at 10%. The CPU 1501 selects the corresponding one of the card dispensers 610 in accordance with these dispense conditions. If the normal cards are loaded into two card dispensers, the dispense probability is set at 35% for each of the card dispensers. This allows these card dispensers to uniformly dispense normal cards. For the selections based on the dispense probabilities, the CPU 1501 executes a random number process. For example, if numerical values from 1 to 10 appear at an equal probability on the basis of the random number process, a normal card is dispensed when 1 or 7 appears. A rare card is dispensed when 8 or 9 appears. A super rare card is dispensed when 10 appears.

In step S1604, the CPU 1501 transmits a dispense signal to the selected card dispenser 610 through the I/O unit 1505. Upon reception of the dispense signal, the card dispenser 610 drives the motor 1302 to dispense one card.

In step S1605, the CPU 1505 determines whether or not the bar code scanner 620 has read data. If the player places any card such as the one dispensed during the last game, on the placement table 621, the bar code scanner 620 reads the bar code from the card. The read data is transferred to the CPU 1501 via the I/O unit 1505. If reading of the bar code has been detected, the CPU 1501 proceeds to step S1606. If the reading is not detected even a specified time after the card has been dispensed, the CPU 1501 ends the card purchase mode.

In step S1606, the CPU 1501 reads information corresponding to the data read by the bar code scanner 620, from the database stored in the HDD 1510 or the like. The information is, for example, fighting ability parameters for game characters.

In step S1607, the CPU 1501 outputs the read information to the display device 601 through a display IF 1504. This enables the card purchaser to check, for example, parameter information on the purchased card.

In the above embodiment, cards are dispensed on the basis of the fixed dispense criteria predefined for the individual card types. However, according to the present invention, the dispense probability may be dynamically varied.

For example, for players who have purchased more cards, the CPU 1501 sets a dispense probability higher than the normal one, for the rare or super rare card. For example, identification cards are issued which have bar codes indicating identification data unique to the players so that when a player purchases cards, the bar code scanner 620 reads the identification card. On the other hand, the CPU 1501 associates the identification data read by the bar code scanner 620 with the number of cards purchased and stores the resulting data in the database in the HDD 1510. When cards are sold, the CPU 1501 reads the data on the number of cards purchased corresponding to the identification data. The CPU 1501 then increases the dispense probability of the rare card depending on the number of cards purchased.

In the above example, the player is identified using the identification card. However, even if a plurality of players use the same card, the CPU 1501 considers that the same player has purchased cards. The CPU 1501 thus increases the number of cards purchased and updates the database. Thus, to more precisely identify the player, it is possible to utilize biometrics information such as fingerprints or the iris.

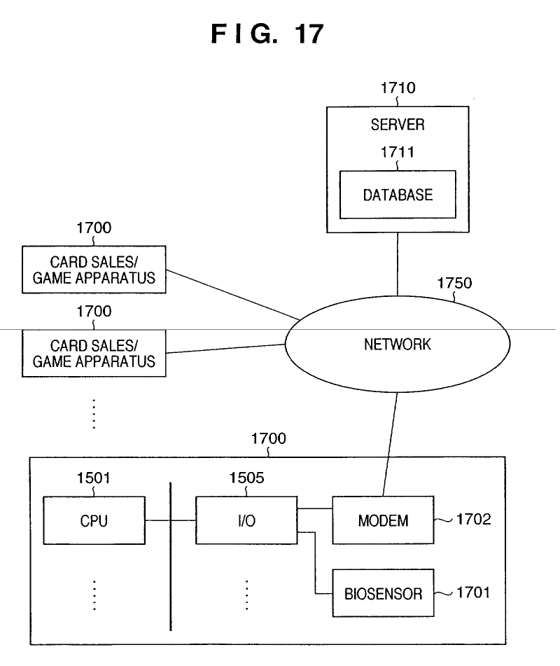

FIG. 17 is a diagram showing an example of an apparatus using a biometrics sensor. The CPU 1501 can more precisely identify players by connecting, to the I/O unit 1505, a sensor 1701 used to acquire biometrics information. In FIG. 17, other components such as those shown in FIG. 15 are omitted.

Moreover, card selling apparatuses 1700 installed throughout the nation may be connected to a network 1750 with the database 1711 retained in a server 1710 on the network. In this manner, the server 1710 can manage each player's purchase history. Consequently, even if the player utilizes a card selling apparatus different from the one he or she usually uses, the player can advantageously purchase cards in accordance with his or her card purchase history.

In the example shown in FIG. 17, the CPU 1501 accesses the server 1710 via a communication device such as a modem 1702 connected to the I/O unit 1505. The CPU 1501 thus reads the number of cards purchased by the player from the database 1711 in the server 1710 or transmits an instruction on an increase in the number of cards purchased to the server 1710.

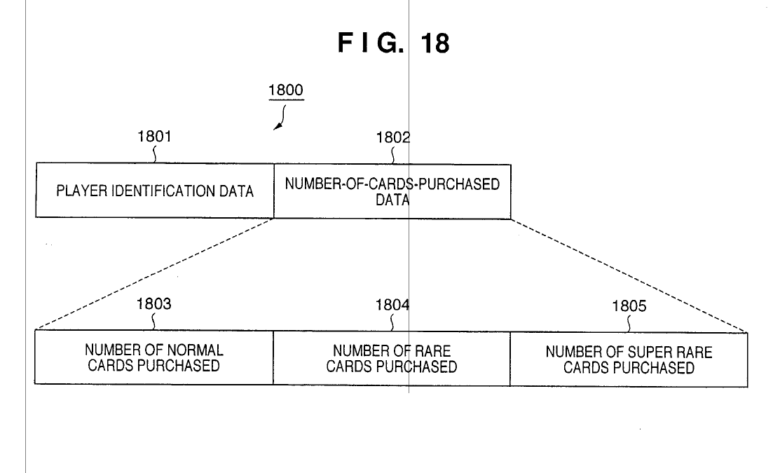

FIG. 18 is a diagram showing an example of the database according to the present embodiment. The database 1711 stores player identification data 1801 and number-of-cards-purchased data 1802 which are associated with each other. The number-of-cards-purchased data 1802 may contain number-of-cards-purchased data on each card type such as number-of-cards-purchased data 1803 on the normal card, number-of-cards-purchased data 1804 on the rare card, and number-of-cards-purchased data 1805 on the super rare card. Of course, only the total number of cards purchased may be stored.

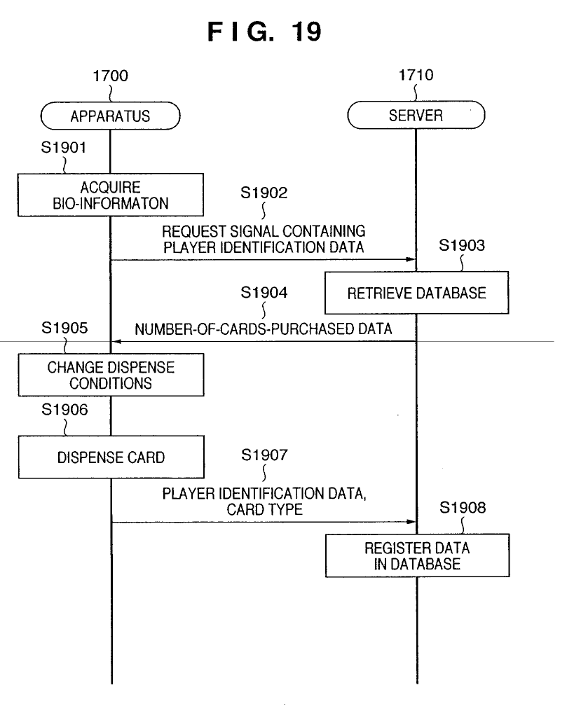

FIG. 19 is a sequence diagram according to the embodiment. In the description below, biometrics information is used as player's identification data. However, the player's identification data may be input using another means such as identification data stored in a bar code in an identification card as described above.

In step S1901, the CPU 1501 uses the biometrics sensor 1701 to acquire biometrics information. In step S1902, the CPU 1501 creates a request (query) for retrieval of number-of-cards-purchased data including the player's identification data. The CPU 1501 transmits the query to the server 1710 via the modem 1702.

In step S1903, the server 1710 receives the retrieval request and searches the database 1711. That is, the server 1710 obtains the player's identification data from the retrieval request. The server 1710 then retrieves and extracts the number-of-cards-purchased data corresponding to the identification data obtained.

In step S1904, the server 1710 transmits the number-of-cards-purchased data to the apparatus 1700. The CPU 1501 in the apparatus 1700 receives the result of retrieval via the modem 1702.

In step S1905, the CPU 1501 changes the dispense conditions on the basis of the number-of-cards-purchased data contained in the received retrieval result. For example, if no rare cards have been purchased even though the total number of cards purchased exceeds a predetermined threshold, the dispense conditions are set so as to dispense a rare card. Alternatively, if the total number of cards purchased exceeds the predetermined threshold, the dispense probability of the normal card is reduced, while the dispense probabilities of the rare and super rare cards are correspondingly increased.

Alternatively, the dispense probability of cards with a low value level may be reduced while the dispense probability of cards with a high value level may be increased, in proportion to the total number of cards purchased.

In step S1906, the CPU 1501 selects one of the card dispensers 610 for dispensation in accordance with the changed dispense conditions. The CPU 1501 then transmits a dispense signal.

In step S1907, the CPU 1501 creates a registration request containing identification data representing the type of card dispensed (the type corresponds to the card dispenser used) and the player's identification data. The CPU 1501 then transmits the registration request to the server 1710.

In step S1908, the server 1710 obtains the identification data on the dispensed card and the player's identification data from the received registration request. Moreover, the server 1710 retrieves and extracts the number-of-cards-purchased data corresponding to the player's identification data, from the database 1711. The server 1710 then increments, by one, the number of cards purchased corresponding to the identification data on the dispensed card to update the database 1711.

As described above, the dispense conditions can be made lenient for players who have purchased many cards by varying the dispense conditions depending on the number of cards purchased by each player. For example, it is possible to increase the dispense probabilities of cards such as rare ones which have relatively high value levels, consistently with the number of cards purchased. That is, the player can be treated well according to the amount of money invested.

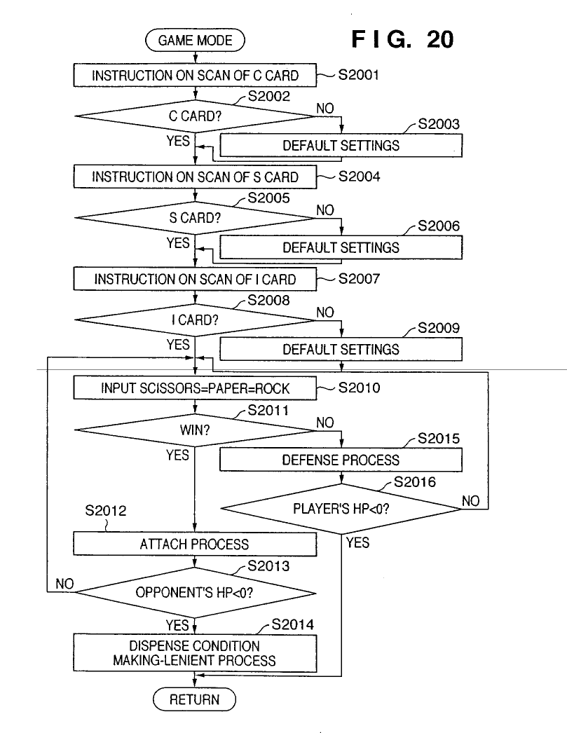

FIG. 20 is a flowchart of an example of a game process according to the present embodiment. This game process corresponds to step S1608, described above. The following three types of cards are used in this example: a character card (C card) used to select a game character, a skill card (S card) used to select the characters' skill, and an item card (I card) used to select an attack item. If no card is scanned, default settings are used so that a player having no cards can play the game.

In step S2001, the CPU 1501 causes the display device 601 to display a message instructing the player to scan a character card. In this case, the sound circuit 1506 may aurally output the message.

In step S2002, the CPU 1501 determines whether or not a character card has been scanned. For example, the CPU 1501 determines that a character card has been scanned when data input by the bar code scanner 620 contains card type data identifying a character card. The CPU 1501 then proceeds to step S2004. If another card has been scanned, the display device 601 may display a message instructing the player to scan the card again. Further, if the CPU 1501 senses an operation of a cancel button disposed on the operation panel 135, it determines that no character card has been scanned. The CPU 1501 then proceeds to step S2003.

In step S2003, the CPU 1501 determines a character using random numbers. The CPU 1501 sets data such as the attack and defense power of the determined character by reading default settings from the ROM 1503.

In step S2004, the CPU 1501 causes the display device 601 to display a message instructing the player to scan a skill card. In this case, the sound circuit 1506 may aurally output the message.

In step S2005, the CPU 1501 determines whether or not a skill card has been scanned. For example, the CPU 1501 determines that a skill card has been scanned when the data input by the bar code scanner 620 contains card type data identifying a skill card. The CPU 1501 then proceeds to step S2007. If another card has been scanned, the display device 601 may display a message instructing the player to scan the card again. Further, if the CPU 1501 senses an operation of the cancel button disposed on the operation panel 135, it determines that no character card has been scanned. The CPU 1501 then proceeds to step S2006.

In step S2006, the CPU 1501 sets data on the skills of the character by reading default settings from the ROM 1503.

In step S2007, the CPU 1501 causes the display device 601 to display a message instructing the player to scan an item card. In this case, the sound circuit 1506 may aurally output the message.

In step S2008, the CPU 1501 determines whether or not an item card has been scanned. For example, the CPU 1501 determines that an item card has been scanned when the data input by the bar code scanner 620 contains card type data identifying an item card. The CPU 1501 then proceeds to step S2010. If another card has been scanned, the display device 601 may display a message instructing the player to scan the card again. Further, if the CPU 1501 senses an operation of the cancel button disposed on the operation panel 135, it determines that no item card has been scanned. The CPU 1501 then proceeds to step S2009.

In step S2009, the CPU 1501 sets data on the items of the character by reading default settings from the ROM 1503.

In step S2010, the CPU 1501 causes the display device 601 to display a message for an instruction on scissors=paper=rock. The player inputs scissors=paper=rock data from the operation panel 135. On the other hand, the CPU 1501 determines scissors=paper=rock data for an opposing character using the random numbers. The CPU 1501 predetermines the opposing character using the random numbers. Default values are used for the skills and items of the opposing character determined.

In step S2011, the CPU 1501 compares the scissors=paper=rock data input from the operation panel 135 with that determined for opposing character. The CPU 1501 thus determines whether or not the player wins. If the player wins, the CPU 1501 proceeds to step S2012. If the player loses, the CPU 1501 proceeds to step S2015.

In step S2012, the CPU 1501 executes an attack process. For example, the CPU 1501 calculates the attack power of the player's character and the defense power of the opposing character on the basis of the above character, skill, and item data. The CPU 1501 further calculates the damage value of the opposing character from the attack power and defense power. Finally, the CPU 1501 subtracts the damage value from the current hit point (HP) of the opposing character.

In step S2013, the CPU 1501 determines whether or not the current HP value of the opposing character is negative. If the value is negative, the CPU 1501 proceeds to step S2014. If the value is positive, the CPU 1501 proceeds to step S2010 to execute the next scissors=paper=rock process.

In step S2014, the CPU 1501 sets card dispense conditions advantageous to the player. That is, the dispense probability of the rare card is set higher than usual, whereas the dispense probability of the normal card is set lower than usual.

On the other hand, in step S2011, if the player loses in the scissors=paper=rock, the CPU 1501 proceeds to step S2015 to execute a defense process. For example, the CPU 1501 calculates the defense power of the player's character and the attack power of the opposing character on the basis of the above character, skill, and item data. The CPU 1501 further calculates the damage value of the player's character from the attack power and defense power. Finally, the CPU 1501 subtracts the damage value from the current hit point (HP) of the player's character.

In step S2016, the CPU 1501 determines whether or not the current HP value of the player's character is negative. If the value is positive, the CPU 1501 proceeds to step S2010 to execute the next scissors=paper=rock process. If the value is negative, the CPU 1501 returns to the main flow with the dispense probability remaining at the usual value.

In this manner, according to the present embodiment, games are played using many types of cards such as the character, skill, and item cards. If the player wins the game, he or she is treated well in connection with the value level of a dispensed card. On the other hand, even if the player loses, a card is dispensed at the usual dispense probability.

With the conventional art, if the player wins the game, two cards are dispensed. If the player loses the game, no cards are dispensed. However, the invention according to the present embodiment ensures that a card is dispensed after the game. Furthermore, with the invention according to the present embodiment, the value level of the dispensed card is controlled depending on whether the player wins or loses the game. For example, if the player wins the game, the dispense probabilities of cards with relatively high value levels are increased. If the player loses the game, the dispense probabilities of cards with relatively high value levels are reduced. This is very effective in enhancing the enjoyment of collection of cards and allowing the player to enjoy the game itself.

In the above embodiment, the characters and their attack power and defense power are determined on the basis of the plurality of cards used. The type of the dispensed game card is indirectly affected. However, according to the present invention, the types of the cards used for the game may directly affect the dispensed card. For example, a table may be stored in the ROM 1503; the table associates combinations of a plurality of cards used for the game with the type of a dispensed card. Then, for each game, the CPU 1501 determines whether or not the combination of cards used has been registered in the table. If the combination has been registered in the table, the CPU 1501 changes the dispense conditions so that the corresponding type of card is reliably dispensed. On the other hand, if the combination of cards used has not been registered in the table, the CPU 1501 uses default dispense conditions.

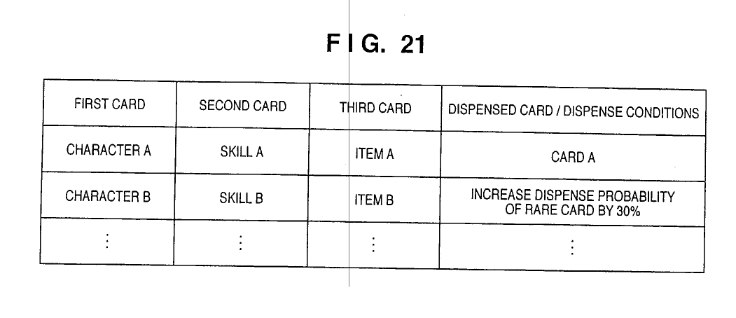

FIG. 21 is a diagram showing an example of a card combination managing table. In this example, a dispensed card and dispense conditions are registered in association with each combination of cards used for the game.

In the above embodiment, a card is dispensed at the end of the game. However, a card may be dispensed according to the progress of the game. For example, when the player beats the first opposing character, the CPU 1501 may dispense a card in accordance with the current card dispense conditions. If the player beats the next character, the CPU 1501 may dispense another card. That is, consecutive wins allow the player to obtain a large number of cards, thus enhancing the player's curiosity about the game.

Alternatively, when the player beats a certain opposing character, the CPU 1501 displays a message on the display device 601, the message requesting the player to choose whether or not to dispense a card. When a dispense selection instruction is input from the operation panel 135, the CPU 1501 dispenses a card without changing the dispense conditions. On the other hand, if the dispensation has not been selected, the CPU 1501 sets the level at which the dispense conditions, when changed, are made lenient, higher than usual and stores the set level in the RAM 1502. If the player consecutively wins a subsequent opposing character, the CPU 1501 changes the dispense condition more lenient one than usual one according to the level. On the other hand, if the player fails to win consecutively, the CPU 1501 sets dispense conditions worse than those used for the last time the player beat the opposing character. That is, the CPU 1501 increases the dispense probability of the rare card if the player wins consecutively. On the other hand, the CPU 1501 sets the dispense probability lower than usual if the player fails to win consecutively. That is, a game mode of high risk and high return is realized, which will attract player's more interest.

As described above, the present embodiment provides a game apparatus comprising a plurality of card dispensers used to dispense game cards, wherein one of the card dispensers can be selected in accordance with predetermined conditions such as cards used for the game. Provision of the plurality of card dispensers increases the number of cards housed, thus making it possible to reduce the number of maintenance operations.

Further, the concepts of the value level and dispense probability are introduced into cards so that an appropriate one of the card dispensers can be used according to the value level or dispense probability. Consequently, cards with different value levels can be selectively dispensed in accordance with dispense conditions determined on the basis of cards used for the game and whether the player wins or loses the game.

Further, for cards with relatively high dispense probabilities, a plurality of card dispensers may be assigned to such a card type to reduce the number of maintenance operations.

Furthermore, by identifying the number of cards purchased by each player, it is possible to make lenient the card dispense conditions for players having purchased a relatively large number of cards. The server can manage the number of cards purchased for all the players so that wherever in the country the player plays the game, the number of cards purchased by the player can be reflected in the card dispense conditions.

Further, when the dispense conditions are determined on the basis of the combination of cards used for the game, the enjoyment of a search for the optimum combination is enhanced.

Furthermore, in inputting coins, the player can choose either the game mode or the card mode. Accordingly, players interested more in collection of cards than in the game itself can purchase cards without the need to play the game. This advantageously makes it possible to reduce the amount of time before the player can purchase the next card. This is also advantageous to the owner of the apparatus because the turnover rate of the apparatus can be increased.

In the above embodiment, the card comprising the bar code is described. However, the present invention is applicable to any card comprising a recording medium on which game data is recorded. Examples of storage media include a magnetic recording medium, an optical recording medium, a memory, an RFID tag, and an IC in a non-contact or contact IC card.

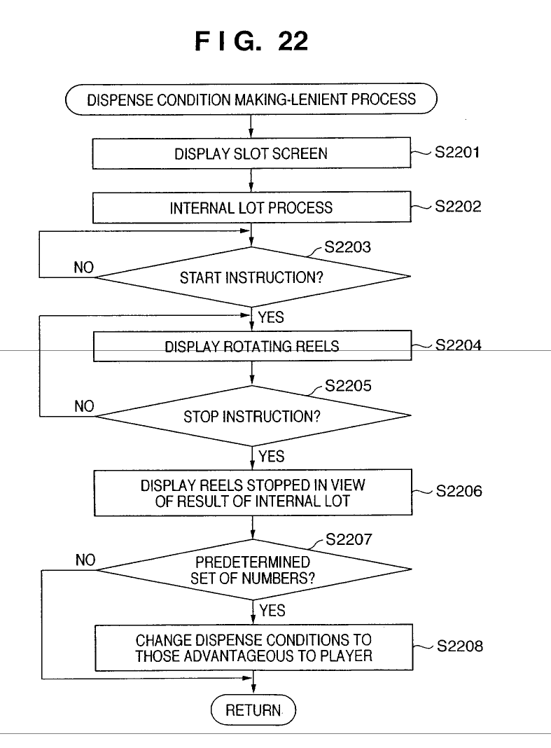

FIG. 22 is a flowchart showing another example of a dispense condition making-lenient process according to the embodiment. As seen in the flowchart, the player participates more deeply in determination of the dispense conditions and can thus enjoy pursuing the skill to cause rare cards to be dispensed. In the description, the flowchart corresponds to a subroutine of step S2014, described above. However, this subroutine may be called in a different scene of the game. Specifically, it may be called when the player loses the game. For example, the CPU 1501 may call the subroutine on determining that a predetermined condition (for example, a scanned card constitutes a particular combination as described for FIG. 21) is met during the game.

In step S2201, the CPU 1501 switches the display of the display device 601 from the game screen to a determination screen used to determine the dispense conditions. Moreover, in the determination screen, the CPU 1501 causes the display device 601 to display a slot machine consisting of three reels. The reels are virtual ones and are provided by graphics display. A large number of patterns are displayed on the surface of each reel.

In step S2202, a random number process is used to draw an internal lot to determine whether or not to use such a set of particular numbers (for example, three sevens) as increases the dispense probability of the rare card. The internal lot is drawn for the following reason. In regard of the relationship between the numbers in the slot and the user's stop input from the operation panel, when the numbers in the slot are set completely dependent on the user's input timing, a person with a good dynamic visual activity can increase the dispense probability (win) to 100%. This impairs the pleasure the player takes in playing the game.

Thus, the internal lot (random number process) is used to determine whether or not to use such a set of particular numbers (for example, three sevens) as increases the dispense probability of the rare card. The user can then concentrate on winning the set of particular numbers. The internal lot in step S2202 is optional and may be omitted.

In step S2203, the CPU 1501 determines whether or not a start instruction has been input using a rotation start button placed on the operation panel 135. When a start instruction is input, the CPU 1501 proceeds to step S2204.

In step S2204, the CPU 1501 causes the display device 601 to provide a display in which the three rolls are rotating.

In step S2205, the CPU 1501 determines whether or not a button has been depressed which is placed on the operation panel 135 to instruct the rotation to be stopped. A number of buttons may be provided which correspond to the number of reels or the rotation of each reel may be stopped by depressing the single button three times. When a stop instruction for the reels is input from the operation panel 135, the CPU 1501 proceeds to step S2206.

In step S2206, in response to the input stop instruction, the CPU 1501 provides a display in which each reel has its rotation speed reduced and is finally stopped. If an internal lot is drawn, the CPU 1501 reads the result of the internal lot from the RAM 1502 to determine whether or not the result of the internal lot indicates the avoidance of the simultaneous display of particular numbers. If the CPU 1501 has already determined the avoidance of the simultaneous display of the particular numbers through a pre-internal-lot, it controls the rotation of at least one reel so as to avoid the simultaneous display of the predetermined particular numbers even if a stop instruction is input at such a time when the particular numbers are simultaneously displayed (specifically, the player needs only one more particular number to win).

Thus, even a person good at causing the reels to simultaneously display the respective particular numbers cannot do so unless provision of this display has internally been determined. Conversely, a person bad at causing the reels to simultaneously display the respective particular numbers cannot do so even if provision of this display has internally been determined.

In step S2207, the CPU 1501 determines whether or not the numbers determined by stopping the reels are the predetermined ones. The predetermined numbers are pre-stored in the ROM 1503 or the like in association with the data on the level at which the dispense conditions are made lenient. When the predetermined numbers are simultaneously displayed, the CPU 1501 proceeds to step S2208. Otherwise the flow shown in the flowchart is finished.

In step S2208, the CPU 1501 changes the dispense conditions so that they are more advantageous than usual. The CPU 1501 then stores the changed conditions in the RAM 1502. For example, the CPU 1501 reads the priority for the set of particular numbers (for example, dispense probability+50%) from the ROM 1503 or the like. The CPU 1501 then rewrites the contents of the dispense condition table in which the associations between the card types and the dispense probabilities are registered. For example, if the dispense probability of the rare card is 20%, it is increased by 50%; the dispense probability is set at 70%. The dispense probabilities of the other card types are correspondingly reduced.

As described above, the player participates more deeply in determination of the dispense conditions and can thus enjoy pursuing the skill to cause rare cards to be dispensed.

In the description of the above embodiments, cards with different value levels are housed in the respective card dispensers, or cards with the same value level are housed in several card dispensers. However, cards of different types may be housed in the respective card dispensers.

For example, the “type” as used in the specification refers to a difference in the role (for example, characters, skills, or items) on the game used. More specifically, character cards may be mounted in the dispenser 1, skill cards may be mounted in the dispenser 2. Item cards may be mounted in the dispenser 3, and rare cards may be mounted in the dispenser 4. The apparatus thus configured enables cards to be dispensed under the dispense conditions described below.

1. It is assumed that if the game apparatus is set so that plural (three) types of cards are scanned before the start of the game or during the game as described above, a certain type of card is not recognized by scan, so that default settings are selected. The CPU 1501 stores the type of the unrecognized card in the RAM 1502. Subsequently, when the player wins the game, the CPU 1501 reads information on the type of the card that has not been scanned from RAM 1502. The CPU 1501 then recognizes the card type on the basis of the read information and increases the dispense probability of the card of this type. This enables the leveling of the types of cards possessed by a certain player.

2. If the player identification data is stored in association with the number of cards purchased as described above, it is possible to recognize the types of cards dispensed to the player. That is, the number of cards possessed by the player can be determined for each card type. Thus, when a card is dispensed to a player, the dispense probability of the card type for which the player has the smallest number of cards is increased for the player. This enables the leveling of the types of cards possessed by a certain player.

The present invention can be applied to a system constituted by a plurality of devices, or to an apparatus comprising a single device. Furthermore, it goes without saying that the invention is applicable also to a case where the object of the invention is attained by supplying a program to a system or apparatus.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-241138 filed on Aug. 20, 2004, which is hereby incorporated by reference herein.

What is claimed is:

1. A card selling apparatus which sells a card comprising a recording medium on which data for a game is recorded, the apparatus comprising:
a housing comprising an output port through which the card is output;
a plurality of card dispensers provided in the housing and in which the cards are housed;
a card guide member that guides the card dispensed by the card dispenser, to the output port;
a selecting unit that selects one of the plurality of card dispensers which dispenses the card, in accordance with predetermined dispense conditions; and
a control unit that transmits a dispense signal to the card dispenser selected by the selecting unit.

2. The card selling apparatus according to claim 1, wherein the dispense conditions are such that a dispense probability is relatively low for a group of cards for which the value level is relatively high and that the dispense probability is relatively high for a group of cards for which the value level is relatively low.

3. The card selling apparatus according to claim 1, wherein the first card group classified into a first value level is loaded into a first of the plurality of card dispensers, and the second card group classified into a second value level higher than the first value level is loaded into a second of the plurality of card dispensers.

4. The card selling apparatus according to claim 3, wherein a third card group classified into a third value level higher than the second value level is loaded into a third of the plurality of card dispensers.

5. The card selling apparatus according to claim 3, wherein the first card group is loaded into the third card dispenser, and the third card dispenser is placed adjacent to the first card dispenser.

6. The card selling apparatus according to claim 1, further comprising:
a card data input unit that inputs the data for the game recorded in the card; and
a dispense condition determining unit that determines the dispense conditions in accordance with the input data.

7. The card selling apparatus according to claim 6, wherein the dispense condition determining unit determines the dispense conditions on the basis of a combination of a plurality of the cards used.

8. The card selling apparatus according to claim 1, further comprising:
a data input unit that inputs unique player identification data used to identify a player;
an acquiring unit that acquires data on the number of cards purchased corresponding to the player identification data input, from a database that stores the player identification data in association with the data on the number of cards purchased by each player; and
a dispense condition determining unit that determines the dispense conditions on the basis of the acquired number of cards purchased.

9. The card selling apparatus according to claim 8, wherein dispense conditions advantageous to the player are determined so that the level of the advantage is in proportion to the number of cards purchased or dispense conditions advantageous to the player are determined if the number of cards purchased exceeds a predetermined threshold.

10. The card selling apparatus according to claim 8, wherein the database is shared by a plurality of card selling apparatuses on a network.

11. The card selling apparatus according to claim 1, further comprising a mode selecting unit that selects either a game mode or a card purchase mode if the card selling apparatus is mounted in a game apparatus,
wherein the control unit skips the game and transmits a card dispense signal if the purchase mode is selected, or transmits the card dispense signal at the end of the game or in accordance with progress of the game if the game mode is selected.
